(19) United States
(12) Patent Application Publication
(10) Pub. No.: US 2008/0197522 A1
(43) Pub. Date: Aug. 21, 2008

(54) DEVICE FOR PRODUCING A SPUN-BONDED NON-WOVEN

(75) Inventors: Matthias Schemken, Neumunster (DE); Henning Rave, Achterwehr (DE); Holger Schottler, Klein Ronnau (DE); Anton Mooshammer, Munchberg (DE)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Oerlikon Textile GmbH & Co. KG

(21) Appl. No.: 11/969,528

(22) Filed: Jan. 4, 2008

Related U.S. Application Data
(63) Continuation of application No. PCT/EP2006/006391, filed on Jun. 30, 2006.

(30) Foreign Application Priority Data
Jul. 5, 2005 (DE) 10 2005 031 324.8

(51) Int. Cl. B29C 47/92

(52) U.S. Cl. 264/40.3; 264/40.7; 264/40.6; 425/66

(57) ABSTRACT

A device and method for producing a spun-bonded non-woven. A molten polymer supplied to a spinning beam from a melt source is extruded through a multiplicity of linearly arranged spinneret bores into filaments arranged in the form of a curtain. A tensile force is exerted on the filaments by means of a draw-off nozzle. The filaments are thereupon deposited on to a conveyer belt where they form a spun-bonded non-woven. At the draw-off nozzle, a monitoring means is provided which detects a characteristic quantity characteristic of the process. One or more structure-borne sound sensors are preferably used as monitoring means. The measurement result of the monitoring means, after a desired value comparison, is supplied to a signal means or is used for regulating the process.

### CROSS-REFERENCE TO RELATED APPLICATIONS

The present application is a Continuation of International Application No. PCT/EP2006/006391, filed Jun. 30, 2006, and which designates the U.S. The disclosure of the referenced application is incorporated herein by reference.

### FIELD OF THE INVENTION

The invention relates to a device for the melt-spinning and draw-off of a multiplicity of filaments and to a method for the melt-spinning and draw-off of a multiplicity of filaments.

### BACKGROUND OF THE INVENTION

WO 97/35053 discloses a generic device, in this case for producing a spun-bonded non-woven. In this device, a molten polymer supplied by an extruder is spun in a spinning beam, through nozzle bores arranged linearly in one or more rows, to form a multiplicity of filaments. A tensile force is exerted on the filaments by means of a slot-shaped draw-off nozzle arranged at some distance beneath them and causes a drafting and conveyance of the filaments. For this purpose, compressed air flows out of the inner wall of the draw-off nozzle in the conveying direction of the filaments, with the result that the desired tensile force is exerted on the filaments. The filaments are deposited in a tangled position on a conveyer belt arranged beneath the draw-off nozzle and form the non-woven there.

Stringent demands as to the quality of the final product and as to the uniformity of the product make it necessary, in automated production, to have measures for process control and regulation. Thus, patent application JP 07-216708 A shows a quality control circuit in which the non-woven produced is detected by means of a sensor. Settings are carried out on the draw-off nozzle as a function of the signal from this sensor or of the deviation of the signal from a reference signal. The sensor used here is a CCD camera which measures the density of the non-woven. This measurement method has the disadvantage that the quality feature of the product is detected only with a delay. Moreover, the sensor technology is highly complicated and is susceptible to contamination.

An object of the invention, therefore, is to provide simple and reliable sensor technology for detecting a quality feature, which detects the measurement result without delay.

### SUMMARY OF THE INVENTION

This object and others are achieved by means of a device for the melt-spinning and draw-off of a multiplicity of filaments. For this purpose, the draw-off nozzle is connected directly to a monitoring means. The advantage of this arrangement is that the monitoring means measures directly in the process. Thus, in the event of possible changes in the process, the measurement results are immediately available without any time delay.

In a preferred embodiment, the monitoring means consists of one or more structure-borne sound sensors. Structure-borne sound is understood to mean transient sound waves which are propagated in the structural part. The sound waves are excited by the aerodynamic actions occurring within the draw-off nozzle. Possibly arising compressed air fluctuations or changes in the nature of the filaments have a pronounced influence on the aerodynamic actions within the draw-off nozzle and can therefore be detected easily. The filaments guided through the draw-off nozzle like-wise influence the aerodynamic boundary conditions. Variations in the filaments can therefore be detected indirectly. The advantage of the invention is that the structure-borne sound sensor can be installed in a simple way, without having to be provided directly within the flow duct of the draw-off nozzle. Instead, it is sufficient if the sensor is connected to the draw-off nozzle so as to conduct structure-borne sound efficiently. For measuring the structure-borne sound, an oscillation sensor is suitable, which converts the mechanical oscillations into electrical signals, particularly in the high-frequency range.

The number of structure-borne sound sensors actually used depends on the structural conditions. With a view to a simple design, a single structure-borne sound sensor is to be preferred. However, since, as a rule, generic draw-off nozzles have a spatial extent which cannot be detected by the sensitivity of a single sensor, it may be necessary to provide on the draw-off nozzle a plurality of structure-borne sound sensors connected in parallel.

Admittedly, it is known from WO 88/08047 for the density of a filament bundle guided through a contraction to be measured by means of a microphone. In this case, the filament bundle to be measured is guided through a funnel-shaped contraction. The friction thereby caused between the filaments themselves and between the filaments and the wall of the contraction gives rise, in conjunction with the movement of the filament bundle, to airborne sound emission which is proportional to the density of the filament bundle. This, however, does not suggest the solution described here, since, in the set object taken as a basis here, a drafting nozzle with the use of compressed air is employed. As is known, compressed air causes disturbing airborne sound emissions. This interference level is higher than the useful signal which is caused by minor variations in the process parameters, thus ruling out sound measurement for a person skilled in the art. Moreover, in the device on which the set object is based, there is no intensive friction between the filaments themselves or between the filaments and the wall.

It was shown that a particularly advantageous place of installation for the structure-borne sound sensors is that region of the draw-off nozzle which is at the rear in the conveying direction. In a preferred embodiment, therefore, the monitoring means is arranged here. This has the advantage, moreover, that the structure-borne sound sensors can easily be mounted from the underside of the draw-off nozzle.

In a particularly advantageous development of the invention, the measurement signal from the monitoring means is utilized, by means of a control apparatus, to compare the actual value with a desired value and, in the event of deviations, to generate a fault signal. This fault signal may be, for example, a warning signal for the operator. Likewise, according to the invention, the fault signal may be understood to mean the communication of a fault to an overriding control. A measurement signal is to be understood here as not only meaning the original signal from the sensor. On the contrary, particularly when a structure-borne sound sensor is used, comprehensive signal pre-processing is assumed here, in order, for example, to determine the signal power occurring in a specific frequency spectrum. Other expedient forms of signal preprocessing are known to a person skilled in the art and are also covered by this invention. The result of this preprocessing of the signal is then compared with the desired value.

In a variant of the development of the invention, the measurement signal from the monitoring means is compared by means of a control apparatus with a desired value, and the deviation is transferred to an overriding control which has means for thereupon carrying out a regulating action on the process.

A preferred embodiment of the device according to the invention is provided for the production of spun-bonded non-woven. For this reason, the spinning beam and the draw-off nozzle have an extent transverse to the conveying direction of the filaments approximately over the width of the spun-bonded non-woven. In this case, as a rule, the orientation is orthogonal to the conveying direction of the spun-bonded non-woven. However, the spinning beam or the draw-off nozzle may also be arranged at an angle of down to 45° with respect to the conveying direction of the spun-bonded non-woven. In this case, the width of the spun-bonded non-woven arises from the projection of the effective width of the spinning beam or of the draw-off nozzle in the conveying direction of the spun-bonded non-woven.

A method according to the invention for the melt-spinning and draw-off of filaments provides the method steps of supplying molten polymer, of extruding filaments, of drawing off the filaments in an airstream by means of a draw-off nozzle and of measuring a signal which is measured by a monitoring means arranged at the draw-off nozzle.

In a preferred variant, this is the signal from one or more structure-borne sound sensors provided on the draw-off nozzle.

So that this signal can be processed further, a characteristic quantity is first formed from the signal. In a preferred variant, this may be the signal power. The signal power represents very effectively the intensity of the actions in the process which are responsible for generating the measurement signal. However, other characteristic quantities, such as mean value, effective value, maximum values, etc., which likewise represent the actions, are also known to a person skilled in the art. These equivalent quantities are likewise covered by the invention.

In a particularly preferred variant of the method, the characteristic quantity is formed within one or more frequency ranges. Thus, it is expedient to take into account only frequency ranges above the frequency excited by rotating or moved machine parts. It is likewise expedient to fade out those frequency ranges which are excited, for example, by airflows which are irrelevant for monitoring purposes. Which frequency ranges are ultimately relevant for monitoring can easily be determined experimentally.

In an alternative method variant, the characteristic quantity will be formed by means of frequency analysis. This includes, for example, the comparison of specific frequency ranges with one another. Thus, the characteristic value formed by the signal strength in one frequency range with respect to the signal strength in a second, if appropriate greater frequency range. Corresponding methods of frequency analysis are known to a person skilled in the art of signal processing. Here, too, which method is ultimately adopted is to be determined experimentally, in that the variations in the frequency range in the event of a fault are analyzed in a directed manner.

The characteristic quantity formed by the abovementioned method alternatives is thereupon compared with a reference value and, in the event of a deviation, a corresponding action is triggered.

The comparison may take place, for example, with a predetermined and stipulated reference value. The reference value may also be determined in the process itself.

Thus, the comparison takes place between the currently measured characteristic quantity and the characteristic quantities which are measured and averaged, if appropriate averaged in a weighted manner, within a specific period of time.

In the case of a spatially extended draw-off nozzle, in a method variant, where a plurality of spatially separate sensors are concerned, these are grouped and the signals from the sensor groups are compared with one another, in order thereby to detect abnormal states. In this case, a sensor group may contain one or more sensors.

The action to be carried out is a communication of the event to the operator or to an overriding control.

In a preferred method variant, the action to be carried out is the variation of a method parameter of the spinning process, via which the actions in the draw-off nozzle are influenced directly or indirectly. Thus, by means of appropriate variations in the operating parameters of the extruder or of the heated spinning beam with an integrated metering pump, the delivery, conveying pressure and temperature of the polymer can be varied for regulating purposes. These parameters influence the actions in the draw-off nozzle indirectly. Direct influencing occurs due to the variation in the compressed air supplied to the draw-off nozzle or in the geometry of the draw-off nozzle. In the case, for example, of a draw-off nozzle of variable width, the flow cross section can be varied in this way.

Which method parameters are ultimately influenced expediently and which characteristic quantity is formed from the measurement signal from the monitoring means are to be determined experimentally in the individual case by a person skilled in the art. Thus, it is perfectly appropriate also to determine various characteristic quantities which in each case give rise to different actions.

### BRIEF DESCRIPTION OF THE DRAWINGS

The inventive device will be described in more detail hereinbelow with the aid of an exemplary embodiment of the inventive apparatus, with reference to the accompanying drawings in which:

FIG. 1 illustrates a device according to the invention for producing a spun-bonded non-woven.

### DETAILED DESCRIPTION OF PREFERRED EMBODIMENTS

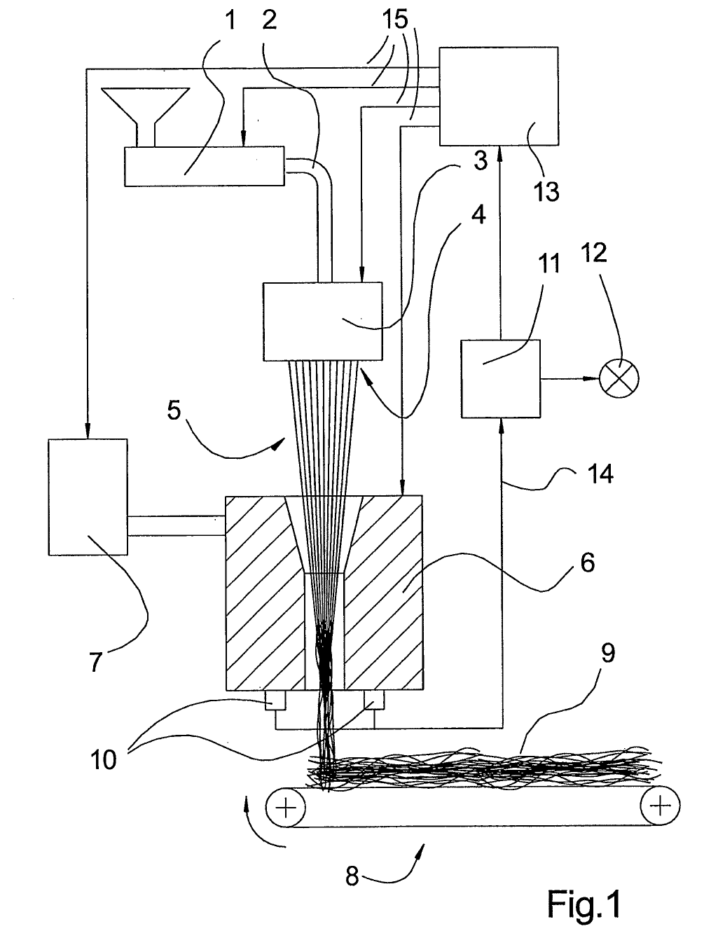

FIG. 1 illustrates a device according to the invention for melt-spinning. This example concerns a device for producing a spun-bonded non-woven. Molten polymer is supplied from a melt source 1, for example an extruder, to the spinning beam 3 via a melt line 2. The spinning beam 3 extends perpendicularly with respect to the drawing plane over a width which corresponds approximately to the width of the spun-bonded non-woven to be produced. The spinning beam 3 has on its underside a multiplicity of spinneret bores 4, through which the molten polymer is conveyed under high pressure and shaped to form filaments 5. The internal set-up of the spinning beam 3 has distributor lines, spinning pumps for a pressure rise and also a heating system and is known from the prior art.

The filaments 5 emerging from the spinning beam 3 are arranged perpendicularly with respect to the drawing plane in the form of a curtain and are supplied to a draw-off nozzle 6. The draw-off nozzle 6 likewise extends perpendicularly with respect to the drawing plane over a width which corresponds approximately to the width of the spun-bonded non-woven to be produced. Compressed air is supplied to the draw-off nozzle 6 from a compressed air source 7 and flows at high velocity through the nozzle in the conveying direction. A tensile force is thereby exerted on the filaments 5. Beneath the draw-off nozzle, a conveyer belt 8 is arranged, onto which the filaments 5 are thrown from the draw-off nozzle 6. In this case, the spun-bonded non-woven 9 is formed, which is transported away continuously by the conveyer belt 8.

A monitoring means 10, here in the form of a plurality of structure-borne sound sensors, is provided on the underside of the draw-off nozzle 6. The measurement value, subjected, if appropriate, to signal preprocessing, from the monitoring means 10 is supplied to a control apparatus 11. Signal preprocessing may be the formation of a characteristic quantity, such as, for example, the signal power in specific frequency ranges, or a frequency analysis. The control apparatus 11 compares the measurement value with a desired value and, in the event of a deviation, supplies the latter to a signal means 12. In this case, the signal means 12 may either be an indicator for the operator or constitute a connection to an overriding control device, to which the fault is communicated.

Alternatively, in the event of a deviation, the control apparatus 11 supplies the plant control 13 with a collecting signal 15 representing the size of the deviation. The plant control 13 has the possibility of acting, as a function of the collecting signal, on the operating parameters of various components of the device for producing a spun-bonded non-woven. These are, for example, the temperature or rotational speed of the extruder (melt source 1), the temperature or pump pressure of the spinning beam 3 and also the pressure or delivery of the compressed air source 7, etc. A direct influencing of the draw-off nozzle 6, in that, for example, the nozzle cross section is varied by means of suitable actuators, is likewise possible and provided.

That which is claimed is:

1. A device for the melt-spinning and draw-off of a multiplicity of filaments, said device comprising:
a melt source for supplying a molten polymer;
a spinning beam having a multiplicity of spinneret bores for extruding the molten polymer into filaments; and
a draw-off nozzle arranged beneath the spinneret bores, the filaments being guidable through the draw-off nozzle, and the draw-off nozzle being designed in such a way that, for the draw-off, a tensile force is exertable on the filaments by means of compressed air,
wherein the draw-off nozzle is connected to a monitoring means for monitoring the draw-off operation.

2. The device as claimed in claim 1, wherein the monitoring means is one or more structure-borne sound sensors.

3. The device as claimed in claim 2, wherein the structure-borne sound sensors are provided on that region of the draw-off nozzle which is at the rear, as seen in the conveying direction of the filaments, and are connected to the draw-off nozzle so as to conduct sound.

4. The device as claimed in claim 1, wherein the monitoring means is connected to a control apparatus which is connected to a signal means for signaling deviations from a reference value.

5. The device as claimed in claim 1, wherein the monitoring means is connected to a control apparatus which, in the event of deviations of the value measured by the monitoring means from a desired value, generates a collecting signal, by means of which a parameter of the production process is varied.

6. The device as claimed in claim 1, wherein at least one of the spinning beam or the draw-off nozzle has an extent transverse to the conveying direction of the filaments.

7. A method for drawing-off a multiplicity of filaments, said method comprising:
extruding filaments from a molten polymer; and
drawing off the filaments by means of a compressed air flow generated by a draw-off nozzle,
wherein at least one measurement signal measured by a monitoring means on the draw-off nozzle is detected for the purpose of monitoring the draw-off operation.

8. The method as claimed in claim 7, wherein the measurement signal is the signal from one or more structure-borne sound sensors.

9. The method as claimed in claim 7, wherein a characteristic quantity is formed from the measurement signal of the monitoring means.

10. The method as claimed in claim 9, wherein the characteristic quantity is a signal power or an equivalent quantity.

11. The method as claimed in claim 9, wherein the characteristic quantity is formed within one or more frequency bands.

12. The method as claimed in claim 9, wherein the characteristic quantity is formed by means of frequency analysis.

13. The method as claimed in claim 9, wherein the characteristic quantity is compared with a reference value and, in the event of deviations from the reference value, an action is triggered.

14. The method as claimed in claim 13, wherein the reference value is a stipulated limit value.

15. The method as claimed in claim 13, wherein the reference value is formed continuously from a predetermined characteristic quantity.

16. The method as claimed in claim 9, wherein the monitoring means is formed from a plurality of sensors which in each case form a plurality of groups, and wherein the reference value of one group is the characteristic quantity of another group.

17. The method as claimed in claim 13, wherein the action is the communication of the event.

18. The method as claimed in claim 13, wherein the action is the variation of a method parameter.

19. The method as claimed in claim 18, wherein the method parameter is a delivery or a conveying pressure of the polymer.

20. The method as claimed in claim 18, wherein the method parameter is a temperature of the polymer.

21. The method as claimed in claim 18, wherein the method parameter is the pressure or the delivery of the compressed air supplied to the draw-off nozzle.

22. The method as claimed in claim 18, wherein the method parameter is a geometric characteristic quantity of the draw-off nozzle.

23. The method as claimed in claim 22 wherein the method parameter is a cross-sectional area of the draw-off nozzle.

24. The method as claimed in claim 9, wherein a plurality of characteristic quantities are formed.

25. The method as claimed in one of claim 13, wherein a plurality of actions are triggered.
